(19) United States
(12) Patent Application Publication
(10) Pub. No.: US 2005/0049865 A1
(43) Pub. Date: Mar. 3, 2005

(54) Automatic speech clasification

(76) Inventors: Zhang Yaxin, Hurstville (AU); He Xin, Shanghai (CN); Ren Xiao-Lin, Shanghai (CN); Sun Fang, Shangai (CN); Tan Hao, Charlottesville, VA (US)

Correspondence Address: MOTOROLA INC, 600 NORTH US HIGHWAY 45, ROOM AS437, LIBERTYVILLE, IL, 60048-5343, US

(21) Appl. No.: 10/925,786

(22) Filed: Aug. 24, 2004

(30) Foreign Application Priority Data
Sep. 3, 2003 (CN) 03157019.4

(51) Int. Cl. G10L 11/00

(52) U.S. Cl. 704/239

(57) ABSTRACT

There is described a method (500) for automatic speech classification performed on an electronic device. The method (500) includes receiving an utterance waveform (520) and processing the waveform (535) to provide feature vectors. Then a step (537) provides for performing speech recognition of the utterance waveform by comparing the feature vectors with at least two sets of acoustic models, one of the sets being a general vocabulary acoustic model set and another of the sets being a digit acoustic model set. The speech recognition step (537) provides candidate strings and associated classification scores from each of the sets of acoustic models. The utterance type is then classified (550) for the waveform based on the classification scores and a selecting step (553) selects one of the candidates as a speech recognition result based on the utterance type. A response is provided (555) depending on the speech recognition result.

### FIELD OF THE INVENTION

This invention relates to automatic speech classification of utterance types for use in automatic speech recognition. The invention is particularly useful for, but not necessarily limited to, classifying utterance types received by a radio-telephone to classify utterances into a digit dialling type or phonebook name dialling.

### BACKGROUND ART OF THE INVENTION

A large vocabulary speech recognition system recognises many received uttered words. In contrast, a limited vocabulary speech recognition system is limited to a relatively small number of words that can be uttered and recognized. Applications for speech recognition systems include recognition of a small number of commands, names or digit dialling of telephone numbers.

Speech recognition systems are being deployed in ever increasing numbers and are being used in a variety of applications. Such speech recognition systems need to be able to recognise accurately received uttered words in a responsive manner without a significant delay before providing an appropriate response.

Speech recognition systems typically use correlation techniques to determine likelihood scores between uttered words (an input speech signal) and characterizations of words in acoustic space. These characterizations can be created from acoustic models that require training data from one or more speakers and are therefore referred to as large vocabulary speaker independent speech recognition systems.

Large vocabulary speech recognition system, a large number of speech models is required in order to sufficiently characterise, in acoustic space, the variations in the acoustic properties found in an uttered input speech signal. For example, the acoustic properties of the phone /a/ will be different in the words “had” and “ban”, even if spoken by the same speaker. Hence, phone units, known as context dependent phones, are needed to model the different sound of the same phone found in different words.

Speech recognition system typically spends an undesirable large portion of time finding matching scores, in the art known as the likelihood scores, between an input speech signal and each of the acoustic models used by the system. Each of the acoustic models is typically described by a multiple Gaussian Probability Density Function (PDF), with each Gaussian described by a mean vector and a covariance matrix. In order to find a likelihood score between the input speech signal and a given model, the input has to be matched against each Gaussian. The final likelihood score is then given as the weighed sum of the scores from each Gaussian member of the model

When automatic speech recognition (ASR) is used in radio telephones, the most suitable applications are digit dialling (digit utterance recognition) and phonebook name dialling (text or phrase utterance recognition). However, there is no grammatical sentence guidance for automatic digit dialling speech recognition (a digit can be followed by any digit). This makes speech recognition for utterances of numbers more prone to errors than speech recognition of natural language utterances.

To obtain improved recognition accuracy, most system developers use an explicit digit acoustic model set specially trained from pure digit strings. While the other applications, such as the phonebook name recognition and command/control word recognition, employ a general acoustic model set which covers all acoustic occurrences in a language. A speech recognizer therefore has to predetermine which recognition task is required before using either the digit acoustic model set or general acoustic model set into the recognition engine. Accordingly, a radio-telephone user has to enter a specific domain command (for digit utterances or language utterances), by any means, to correctly start the recognition task. A practical example is that the user may push a different button to perform one of the two kinds of recognitions, or use command recognition by saying “digit dialling”, or “name dialling”, to enter the specific domain. However, the former solution may cause confusion of users and the later delays the recognition time and brings users inconvenience.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for automatic speech classification performed on an electronic device, the method comprising:
receiving an utterance waveform;
processing the waveform to provide feature vectors representing the waveform;
performing speech recognition of the utterance waveform by comparing the feature vectors with at least two sets of acoustic models, one of the sets being a general vocabulary acoustic model set and another of the sets being a digit acoustic model set, the performing providing candidate strings and associated classification scores from each of the sets of acoustic models;
classifying an utterance type for the waveform based on the classification scores;
selecting one of the candidates as a speech recognition result based on the utterance type; and
providing a response depending on the speech recognition result.

Suitably, the performing includes:
performing general speech recognition of the feature vectors with the general vocabulary acoustic model set to provide a general vocabulary accumulated maximum likelihood score for word segments of the utterance waveform; and
performing digit speech recognition of the feature vectors with the digit acoustic model set to provide a digit vocabulary accumulated maximum likelihood score for word segments of the utterance waveform.

Preferably, the classifying includes evaluating the general vocabulary accumulated maximum likelihood score against the digit vocabulary accumulated maximum likelihood score to provide the utterance type

Suitably, the performing general speech recognition provides a general score, the general score being calculated from a selected number of best accumulated maximum likelihood scores obtained from the performing general speech recognition.

The performing digit speech recognition suitably provides a digit score, the digit score being calculated from a selected number of best accumulated maximum likelihood scores obtained from the performing digit speech recognition.

The evaluating also suitably includes evaluating the general score against the digit score to provide the utterance type.

The processing suitably includes partitioning the waveform into word segments comprising frames, the word segments being analyzed to provide the feature vectors representing the waveform

Suitably, the performing general speech recognition suitably provides an average general broad likelihood score per frame of a word segment.

Suitably, the performing digit speech recognition suitably provides an average digit broad likelihood score per frame of a word segment.

The evaluating also suitably includes evaluating the average general broad likelihood score per frame against the average digit broad likelihood score per frame for the utterance waveform.

Suitably, the performing general speech recognition suitably provides an average general speech likelihood score per frame, excluding non-speech frames, of the utterance waveform.

Suitably, the performing digit speech recognition suitably provides an average digit speech likelihood score per frame, excluding non-speech frames, of the utterance waveform.

The evaluating also suitably includes evaluating the average general speech likelihood score per frame against the average digit speech likelihood score per frame to provide the utterance type.

Suitably, the performing general speech recognition suitably identifies a maximum general broad likelihood frame score of the utterance waveform.

Suitably, the performing digit speech recognition suitably provides a maximum digit broad likelihood frame score of the utterance waveform.

The evaluating also suitably includes evaluating the maximum general broad likelihood frame score against the maximum digit broad likelihood frame score to provide the utterance type.

Suitably, the performing general speech recognition suitably identifies a minimum general broad likelihood frame score of the utterance type.

Suitably, the performing digit speech recognition provides a minimum digit broad likelihood frame score of the utterance type.

The evaluating also suitably includes evaluating the minimum general broad likelihood segment score against the minimum general broad likelihood segment score to provide the utterance type.

Preferably, the evaluating is suitably performed by a classifier trained on both digit strings and text strings. The classifier preferably is a trained artificial neural network.

Suitably, the general vocabulary acoustic model set is a set of phoneme models. The phoneme models may comprises Hidden Markov Models. The Hidden Markov Models may model tri-phones.

Preferably the response includes a control signal for activating a function of the device. The response may be a telephone number dialing function when the utterance type is identified as a digit string, wherein the digit sting is a telephone number.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of an electronic device in accordance with the present invention;

FIG. 2 is a schematic diagram of classifier forming part of the electronic device of FIG. 1;

FIG. 3 is a state diagram illustrating a Hidden Markov Model for a phoneme stored in a general acoustic model set store of the electronic device of FIG. 1;

FIG. 4 is a state diagram illustrating a Hidden Markov Model for a digit stored in a digit acoustic model set store of the electronic device of FIG. 1; and

FIG. 5 is a flow diagram illustrating a method for automatic speech classification performed on the electronic device of FIG. 1 in accordance with the present invention.

### DETAILED DESCRIPTION OF THE PREFERRED EMBODIMENT OF THE INVENTION

Referring to FIG. 1 there is illustrated an electronic device 100, in the form of a radio-telephone, comprising a device processor 102 operatively coupled by a bus 103 to a user interface 104 that is typically a touch screen or alternatively a display screen and keypad. The user interface 104 is operatively coupled, by the bus 103, to a front-end signal processor 108 having an input port coupled to receive utterance from a microphone 106. An output of front-end signal processor 108 is operatively coupled to a recognizer 110.

The electronic device 100 also has a general acoustic model set store 112 and a digit acoustic model set store 114. Both stores 112 and 114 are operatively coupled to the recognizer 110, and recognizer 110 is operatively coupled to a classifier 130 by bus 103. Also, bus 103 couples the device processor 102 to classifier 130, recognizer 110, a Read Only Memory (ROM) 118, a non-volatile memory 120 and a radio communications unit 116.

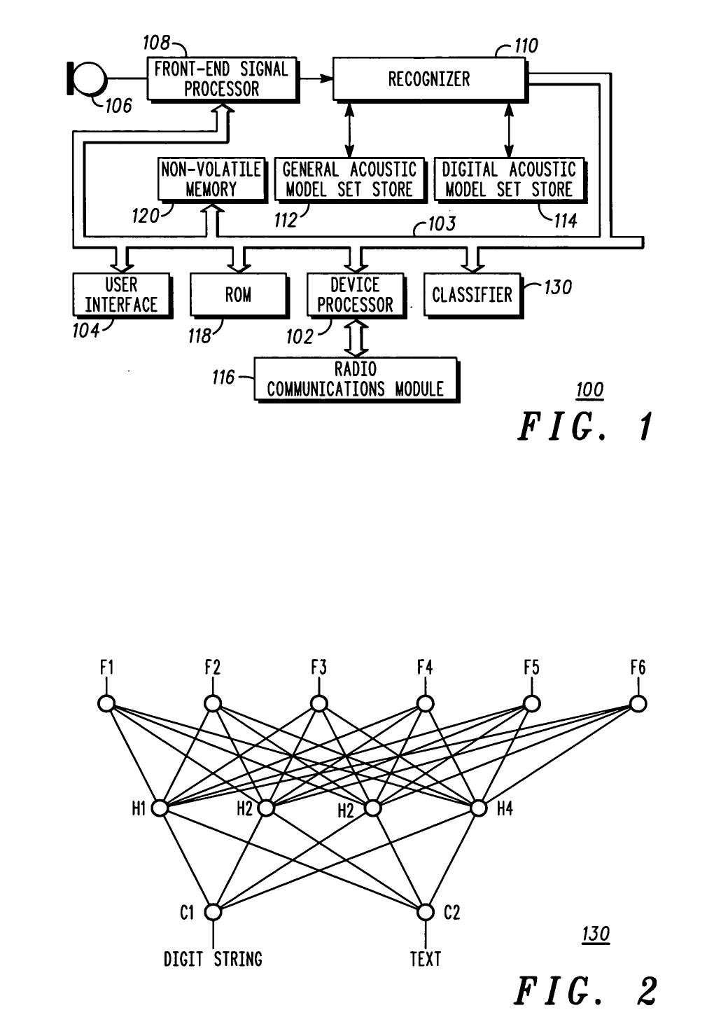

As will be apparent to a person skilled in the art, the radio frequency communications unit 116 is typically a combined receiver and transmitter having a common antenna. The radio frequency communications unit 116 has a transceiver coupled to antenna via a radio frequency amplifier. The transceiver is also coupled to a combined modulator/demodulator that couples the communications unit 116 to the processor 102. Also, embodiment the non-volatile memory 120 stores a user programmable phonebook database Db and Read Only Memory 118 stores operating code (OC) for device processor 102 and code for performing a method as described below with reference to FIGS. 2 to 5.

Referring to FIG. 2 there is illustrated a detailed diagram of the classifier 130 that in this embodiment is a trained Multi-Layer Perceptron (MLP) Artificial Neural Network (ANN). The classifier 130 is a three layer classifier consisting of: a six node input layer for receiving observations F1, F2, F3, F4, F5 and F6; a four node hidden layer H1, H2, H3 and H4; and a two output classification layer C1 and C2. The function Func1(x) of the hidden layer H1, H2, H3 and H4 is:

$$Func1 ( x ) = \frac{2}{1 + exp ( - 2 x )} - 1 ,$$

where x is the value of each observation (F1 to F6). The function Func2(x) of the output classification layer C1 and C2 is:

$$Func2 ( x ) = \frac{1}{1 + exp ( - x )}$$

The well-known Levenberg-Marquardt (LM) algorithm is employed for training the ANN. This algorithm is a network training function that updates weights and bias values according to LM optimization. The Levenberg-Marquardt algorithm is described in “Martin T. Hagan and Mohammad B. Menhaj “Training feed-forward networks with the Marquardt algorithm”, IEEE Trans on Neural Networks, Vol 5, No 6, November 1994, and is incorporated by reference into this specification.

The observations F1 to F6 are determined from the following calculations:
F1=(fg1−fd1)/k1;
F2=(fg2−fd2)/k2;
F3=(fg3−fd3)/k3;
F4=(fg4−fd4)/k4;
F5=fg5/fd5; and
F6=fg6/fd6.

Where K1 to K4 are scaling constants determined by experimentation and k1, k2 are set to 1,000 and k3, k4 are set to 40. Also fg1 to fg6 and fd1 to fd6 are classification scores represented as logarithmic values (log₁₀) determined as follows:
fg1 is a general vocabulary accumulated maximum likelihood score for all word segments of the utterance waveform, this accumulated score is the sum of all likelihood scores, obtained from the performing general speech recognition on the utterance waveform, for all word segments in the utterance waveform (a word segment may either be a word or digit);
fd1 is a digit vocabulary accumulated maximum likelihood score for all word segments of the utterance waveform, this accumulated score is the sum of all likelihood scores, for all word segments in the utterance waveform, obtained from the performing digit speech recognition on the utterance waveform (a word segment may either be a word or digit);
fg2 is a general score being calculated from a selected number of best accumulated maximum likelihood scores for all word segments obtained from the performing general speech recognition on the utterance waveform, typically this score is calculated as an average score from a top five general vocabulary candidates maximum likelihood scores from the general acoustic model set;
fd2 is a digit score being calculated from a selected number of best accumulated maximum likelihood scores for all word segments obtained from the performing digit speech recognition on the utterance waveform, typically this score is calculated as an average score from a top five digit vocabulary candidates maximum likelihood scores from the digit acoustic model set;
fg3 is an average general broad likelihood score per frame of a word segment, where each word segment is partitioned into a plurality of such frames (typically in 10 millisecond intervals);
fd3 is an average digit broad likelihood score per frame of a word segment, where each word segment is partitioned into a plurality of such frames;
fg4 is an average general speech likelihood score per frame, excluding non-speech frames, of the utterance waveform;
fd4 is an average digit speech likelihood score per frame, excluding non-speech frames, of the utterance waveform;
fg5 is a maximum general broad likelihood frame score (ie max fg3) of the utterance waveform;
fd5 is a maximum digit broad likelihood frame score (ie max fd3) of the utterance waveform;
fg6 is a minimum general broad likelihood frame score (ie min fg3) of the utterance waveform; and
fd6 is a minimum digit broad likelihood frame score (ie min fd3) of the utterance waveform.

Referring to FIG. 3 there is illustrated state diagram of a Hidden Markov Model (HMM) that for modeling a general vocabulary acoustic model set stored in the general acoustic model set store 112. The state diagram illustrates one of the many phoneme acoustic models, comprising an acoustic model set, in store 112 each is phoneme acoustic model being modeled by three states s₁, S₂, S₃. Associated with each state are transition probabilities, where a₁₁ and a₁₂ are transition probabilities for state S₁, a₂₁ and a₂₂ are transition probabilities for state S₂, and a₃₁ and a₃₂ are transition probabilities for state S₃. Thus as will be apparent to a person skilled in the art, the state diagram is a context dependent tri-phone with each state S₁, S₂, s₃ having a Gaussian mixture typically comprising between 6-64 components. Also the middle state S₂ is regarded as the stable state of a phoneme HMM while the other two states are transition states describing the co-articulation between two phonemes.

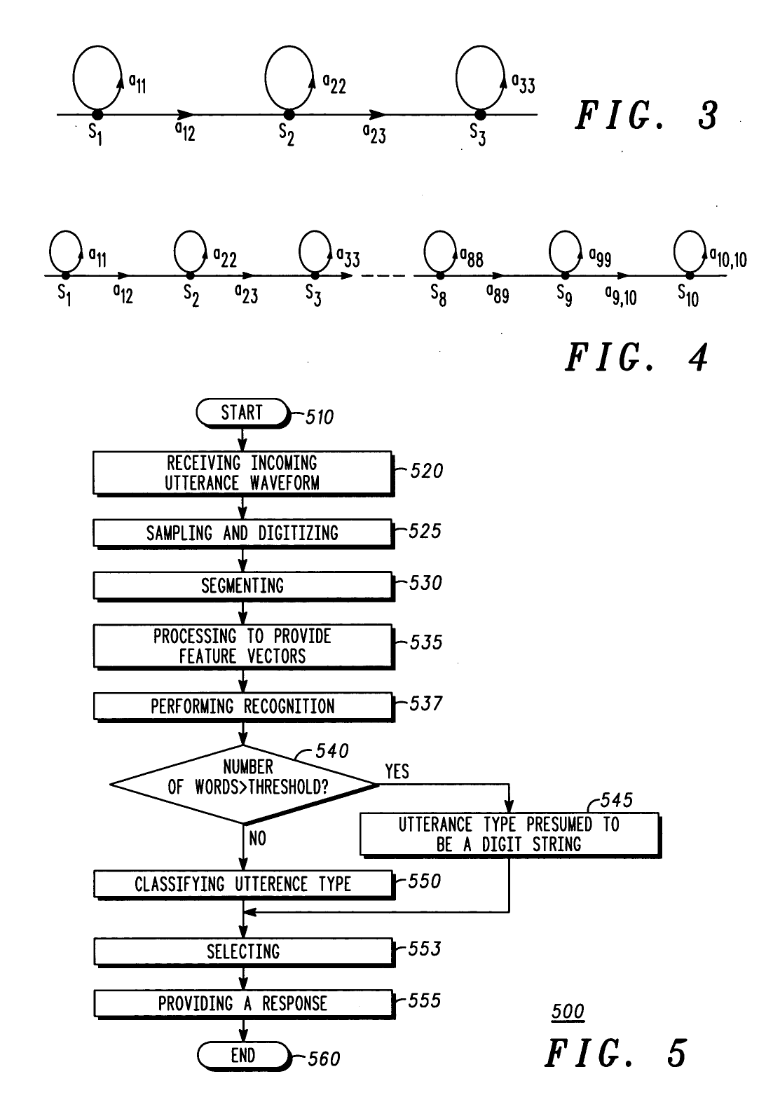

Referring to FIG. 4 a state diagram illustrating a Hidden Markov Model for a digit, forming a digit acoustic model set, stored in the digit acoustic model set store 114. The state diagram is for a digit modeled by ten states S₁ to S₁₀ and associated with each state are respective associated transition probabilities, where a₁₁ and a₁₂ are transition probabilities for state S₁ and all other transition probabilities for each state follow a similar alphanumeric identification protocol. The digit acoustic model set store 114 only need to model 10 digits (digits 0 to 9) and therefore only 11 HHMs (acoustic models) are required. These 11 models being for digits uttered as: “zero”, “oh”, “one”, “two”, “three”, “four”, “five”, “six”, “seven”, “eight” and “nine”. However, this number of models may vary depending on the language in question or otherwise. For instance, “nought” and “nil” may be added as models for the digit 0.

Referring to FIG. 5, there is illustrated a method 500 for automatic speech classification performed on the electronic device 100. After a start step 510, invoked by a user typically providing an actuation signal at the interface 104, the method 500 performs a step 520 for receiving an utterance waveform input at microphone 106. The front-end signal processor 108 then performs sampling and digitizing the utterance waveform at a step 525, then segmenting into frames at a step 530 before processing to provide feature vectors representing the waveform at a step 535. It should be noted that steps 520 to 535 are well known in the art and therefore do not require a detailed explanation.

The method 500 then, at a performing recognition step 537 performs speech recognition of the utterance waveform by comparing the feature vectors with at least two sets of acoustic models, one of the sets being the general vocabulary acoustic model set stored in store 112 and another of the sets being the digit acoustic model set stored in store 114. The performing provides candidate strings (text or digits) and associated classification scores from each of the sets of acoustic models. At a test step 540, the method 500 then determines if a number of words in the utterance waveform is greater than a threshold value. This test step 540 is optional and is specifically for use in identifying and classifying the utterance waveform as digit dialing of telephone numbers. If number of words in the utterance waveform is greater than a threshold value (typically this value is 7) then the utterance type at step 545 is presumed to be a digit string and a type flag TF is set to type digit string. This is based on an assumption that the method is used for telephone name or digit dialing recognition only. Alternatively, if at test step 540 the number of words in the utterance waveform is determined to be less than the threshold value, then a classifying step 550 is effected. The classifying is effected by the recognizer 110 providing observation values for F1 to F6 to the classifier 130. Hence, classifying of the utterance type is provided at step 550 based on the classification scores fg1 to fg6 and fd1 to fd6. As a result, the utterance type is either a digit string or text string (possibly comprising words and numbers) and thus the type flag TF is set accordingly.

After steps 545 or 550 a selecting step 553 selects one of the candidate strings as a speech recognition result based on the utterance type. A providing step 555 performed by recognizer 110 provides a response (recognition result signal) depending on the speech recognition result. The method 500 then terminates at an end step 560.

The performing speech recognition includes performing general speech recognition of the feature vectors with the general vocabulary acoustic model set of store 112 to provide values for fg1 to fg6. The performing speech recognition also includes performing digit speech recognition of the feature vectors with the digit acoustic model set 114 to provide values for fd1 to fd6. The classifying step 550 then provides for evaluating observations F1 to F6 as described above and these observations are fed to classifier 130 to provide the utterance type of C1 (digit string) or C2 (text string). The utterance waveform can therefore be simply recognized as all the searching and likelihood scoring has already been conducted. Thus the device 100 uses the results from either the general acoustic model set or digit acoustic model set for speech recognition and providing the response.

Advantageously, the present invention allows for speech recognition to effect commands for device 100 and overcomes or at least alleviates one or more of the problems associated with the prior art speech recognition and command responses. These commands are typically input by user utterances detected by the microphone 106 or other input methods such as speech received remotely by radio or networked communication links. The method 500 effectively receives an utterance at step 520 and the response at step 555 includes providing a control signal for controlling the device 100 or activating a function of the device 100. Such a function, when the utterance type is a text string, can be traversing a menu or selecting a phone number associated with a name corresponding to a received utterance of step 520. Alternatively, when the utterance type is a digit string then a digit dialling of a telephone number (telephone number dialing function) is typically invoked the numbers for dialling being obtained by the recognizer 110 using the digit model to determine the digits in the waveform utterance represented by the feature vectors.

The detailed description provides a preferred exemplary embodiment only, and is not intended to limit the scope, applicability, or configuration of the invention. Rather, the detailed description of the preferred exemplary embodiment provides those skilled in the art with an enabling description for implementing preferred exemplary embodiment of the invention. It should be understood that various changes may be made in the function and arrangement of elements without departing from the spirit and scope of the invention as set forth in the appended claims.

1. A method for automatic speech classification performed on an electronic device, the method comprising: Receiving an utterance waveform;
processing the waveform to provide feature vectors representing the waveform;
performing speech recognition of the utterance waveform by comparing the feature vectors with at least two sets of acoustic models, one of the sets being a general vocabulary acoustic model set and another of the sets being a digit acoustic model set, the performing providing candidate strings and associated classification scores from each of the sets of acoustic models;
classifying an utterance type for the waveform based on the classification scores;
selecting one of the candidates as a speech recognition result based on the utterance type; and
providing a response depending on the speech recognition result.

2. A method for automatic speech classification as claimed in claim 1, wherein the performing includes:
performing general speech recognition of the feature vectors with the general vocabulary acoustic model set to provide an general vocabulary accumulated maximum likelihood score for word segments of the utterance waveform; and
performing digit speech recognition of the feature vectors with the digit acoustic model set to provide a digit vocabulary accumulated maximum likelihood score for word segments of the utterance waveform.

3. A method for automatic speech classification as claimed in claim 2, wherein the classifying includes evaluating the general vocabulary accumulated maximum likelihood score against the digit vocabulary accumulated maximum likelihood score to provide the utterance type.

4. A method for automatic speech classification as claimed in claim 3, wherein the performing general speech recognition provides a general score, the general score being calculated from a selected number of best accumulated maximum likelihood scores obtained from the performing general speech recognition.

5. A method for automatic speech classification as claimed in claim 4, wherein he performing digit speech recognition provides a digit score, the digit score being calculated from a selected number of best accumulated maximum likelihood scores obtained from the performing digit speech recognition.

6. A method for automatic speech classification as claimed in claim 5, wherein the evaluating also includes evaluating the general score against the digit score to provide the utterance type.

7. A method for automatic speech classification as claimed in claim 3, wherein the processing includes partitioning the waveform into word segments comprising frames, the word segments being analyzed to provide the feature vectors representing the waveform.

8. A method for automatic speech classification as claimed in claim 7, wherein the performing general speech recognition provides an average general broad likelihood score per frame of a word segment.

9. A method for automatic speech classification as claimed in claim 8, wherein the performing digit speech recognition provides an average digit broad likelihood score per frame of a word segment.

10. A method for automatic speech classification as claimed in claim 9, wherein the evaluating also includes evaluating the average general broad likelihood score per frame against the average digit broad likelihood score per frame for the utterance waveform.

11. A method for automatic speech classification as claimed in claim 10, wherein the performing general speech recognition provides an average general speech likelihood score per frame, excluding non-speech frames, of the utterance waveform.

12. A method for automatic speech classification as claimed in claim 11, wherein the performing digit speech recognition provides an average digit speech likelihood score per frame, excluding non-speech frames, of the utterance waveform.

13. A method for automatic speech classification as claimed in claim 12, wherein the evaluating also includes evaluating the average general speech likelihood score per frame against the average digit speech likelihood score per frame to provide the utterance type.

14. A method for automatic speech classification as claimed in claim 13, wherein the performing general speech recognition identifies a maximum general broad likelihood frame score of the utterance waveform.

15. A method for automatic speech classification as claimed in claim 14, wherein the performing digit speech recognition provides a maximum digit broad likelihood frame score of the utterance waveform.

16. A method for automatic speech classification as claimed in claim 15, wherein evaluating also includes evaluating the maximum general broad likelihood frame score against the maximum digit broad likelihood frame score to provide the utterance type.

17. A method for automatic speech classification as claimed in claim 16, wherein the performing general speech recognition identifies a minimum general broad likelihood frame score of the utterance type.

18. A method for automatic speech classification as claimed in claim 17, wherein the performing digit speech recognition provides a minimum digit broad likelihood frame score of the utterance type.

19. A method for automatic speech classification as claimed in claim 18, wherein the evaluating also includes evaluating the minimum general broad likelihood segment score against the minimum general broad likelihood segment score to provide the utterance type.

20. A method for automatic speech classification as claimed in claim 19, wherein the evaluating is performed by a classifier trained on both digit strings and text strings.

21. A method for automatic speech classification as claimed in claim 3, wherein the response includes a control signal for activating a function of the device.

22. A method for automatic speech classification as claimed in claim 21, wherein the response includes a telephone number dialing function when the utterance type is identified as a digit string, wherein the digit sting is a telephone number.
